(19) United States
(12) Patent Application Publication
(10) Pub. No.: US 2005/0075991 A1
(43) Pub. Date: Apr. 7, 2005

(54) System and method for accessing a remote postage meter account from a device that has a dedicated local meter and account

(75) Inventor: Craig Ogg, Long Beach, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Stamps.com Inc, Santa Monica, CA (US)

(21) Appl. No.: 10/677,829

(22) Filed: Oct. 2, 2003

(51) Int. Cl. G06F 17/60

(52) U.S. Cl. 705/408

(57) ABSTRACT

A system and method for printing postage on a local postage evidencing device using a remote postage account comprising a local postage evidencing device having a local postage account, at least one remote postage evidencing system having one or more remote postage accounts, and a communication link between the local postage evidencing device and the at least one remote postage evidencing device, wherein postage value is transferred via the communication link to allow users to print postage on the local postage evidencing device.

### CROSS-REFERENCE TO RELATED APPLICATIONS

The present application is related to co-pending U.S. patent application Ser. No. 10/606,579, entitled “SYSTEM AND METHOD FOR AUTOMATICALLY PROCESSING MAIL,” filed Jun. 26, 2003; co-pending U.S. patent application Ser. No. 10/643,745, entitled “SYSTEM AND METHOD FOR DYNAMICALLY PARTITIONING A POSTAGE EVIDENCING METER,” filed Aug. 19, 2003; and to concurrently filed, co-pending and commonly assigned U.S. Patent Application No. [[Attorney Docket No. 61135-P019US-10303184]], entitled “SYSTEM AND METHOD FOR HIGH-SPEED POSTAGE APPLICATION MANAGEMENT, the disclosures of which are hereby incorporated by reference.

### TECHNICAL FIELD

The present invention relates to postage usage, and more specifically to a system for choosing between a remote postage account and a local postage account.

### BACKGROUND OF THE INVENTION

A variety of devices are available to dispense postage. A postage meter is typically located in a company mailroom for postage on company mail. Individual or companies can also use Internet-based postage accounts, such as an account with Stamps.com, in order to purchase and print postage via the Internet. Self-service kiosks are also known to provide a location where users can purchase and print stamps.

Each of these postage systems is a closed system. They do not interact with each other and each requires a separate postage account balance in order to evidence postage. For example, an individual or company might have $50 worth of postage on account with the United States Postal Service (USPS), in addition to $50 worth of postage on a mailroom postage meter and $20 worth of postage in an Internet postage account. However, the user cannot transfer amounts among these accounts. Thus, the user is forced to carry balances for each of these postage accounts and must pay for postage on a one-time basis or create another account to pay for postage on other devices.

For example, in the kiosk environment, a user is forced to charge his/her credit card to purchase postage even though the user already has money on deposit with the USPS for postage. The kiosk does not have the capability to access the user's USPS account to charge for the postage. As a result, users must maintain multiple postage accounts and must separately account for each of those accounts.

### SUMMARY OF THE INVENTION

The present invention is directed to a system and method that allows a postage metering device to access both a local postage account and a remote postage account. The invention allows the user to take advantage of a remote postage account, such as an online postage service or a USPS postage account, and to access that postage account to print postage using a postage meter that is not directly related to the postage account. The postage meter or other postage evidencing device that is traditionally part of a closed system communicates with other postage devices over the Internet or other communication link.

The postage meter is also able to use a local or proprietary postage account to evidence postage. For example, a mailroom postage meter continues to record a balance locally on the meter. However, the present invention allows a user to access an on-line postage account to use the mailroom postage meter. Any postage then evidenced is subtracted from the postage balance at the online postage service, thereby maintaining the same local meter balance. Similarly, in the self-service kiosk environment, instead of requiring a credit or debit card to purchase postage, the user accesses their remote postage account and takes advantage of the funds that are already on deposit. Accordingly, the user does not have to authorize new funds to be used for postage.

One embodiment of the invention is directed to a system for printing postage on a local postage evidencing device using a remote postage account comprising a local postage evidencing device having a local postage account, at least one remote server system having one or more remote postage accounts, and a communication link between the local postage evidencing device and the at least one remote server system, wherein postage value is transferred via the communication link to allow users to print postage on the local postage evidencing device.

In embodiments of the invention, the local postage evidencing device is a postage meter, and the local postage account is a set of registers that reflect the amount of postage that is currently authorized on the device. Alternatively, the local postage evidencing device is a postage dispensing kiosk, and the local postage account is an amount of postage purchased by a user at the kiosk. In another embodiment, the local postage evidencing device is a personal computer coupled to a printer, and the local postage account is a stored value of postage that has been downloaded from an Internet-based postage service.

In one embodiment, the local postage device, which may be a postage meter, personal computer, postage kiosk or other device, connects to a remote server for authorization to print a certain amount of postage. The user has an account stored on the remote server or is authorized to use an account on the remote server. The user identifies a desired amount of postage on the local postage device, which then requests authorization to print the postage for the user. For security purposes, the remote server does not transfer actual value to the local postage device. Instead, after verifying that the user is authorized to use the postage account and that the account has sufficient value, the remote server debits the cost of the postage from the account and generates the requested postage.

The postage may be in the form of Information Based Indicia (IBI) that complies with the requirements set out in the USPS' Performance Criteria for Information-Based Indicia. Alternatively, the postage may be in any other form of data that includes the requested postage amount and security information, such as a digital signature. In one embodiment, the postage data is a 2-dimensional bar code. The remote server system transfers the postage data to the local postage device, which generates and prints the postage data, for example, in the form of a 2-D bar code.

The remote server system may be an Internet-based postage service or a postage account established by the USPS. The communication link between the local postage evidencing device and the remote postage evidencing system may be a wireline connection or a wireless connection. Security is a concern for storage of the postage data, if the local postage evidencing device does not have a secure method of storing postage value, then the remote server will only send postage data, such as a 2-D bar code, to the local postage device. If, on the other hand, the local postage evidencing device has a secure storage device, then the remote server may transfer the value of the postage to the local device, which then generates the postage indicia locally.

In another embodiment of the invention, a method of accessing a remote postage account from a local postage evidencing device having a dedicated local postage account comprises connecting to a remote server system via a local postage evidencing device, identifying a remote postage account on the remote server system that is to be used to print postage on the local postage evidencing device, selecting a desired postage amount to be printed on the local postage evidencing device, and receiving an authorization from the remote server system to print the desired postage amount on the local postage evidencing device.

The method further comprises printing the desired postage amount on the local postage evidencing device without reducing a balance on the local postage account, and/or authenticating a user with the remote server system. The method provides for a connection to the remote server system using a wireless connection or a wireline connection. The method alternatively includes identifying a user to the local postage evidencing device using a biometric input.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a system incorporating an embodiment of the present invention; and

FIG. 2 is a flowchart illustrating a process for using a remote postage account according to embodiments of the present invention.

### DETAILED DESCRIPTION

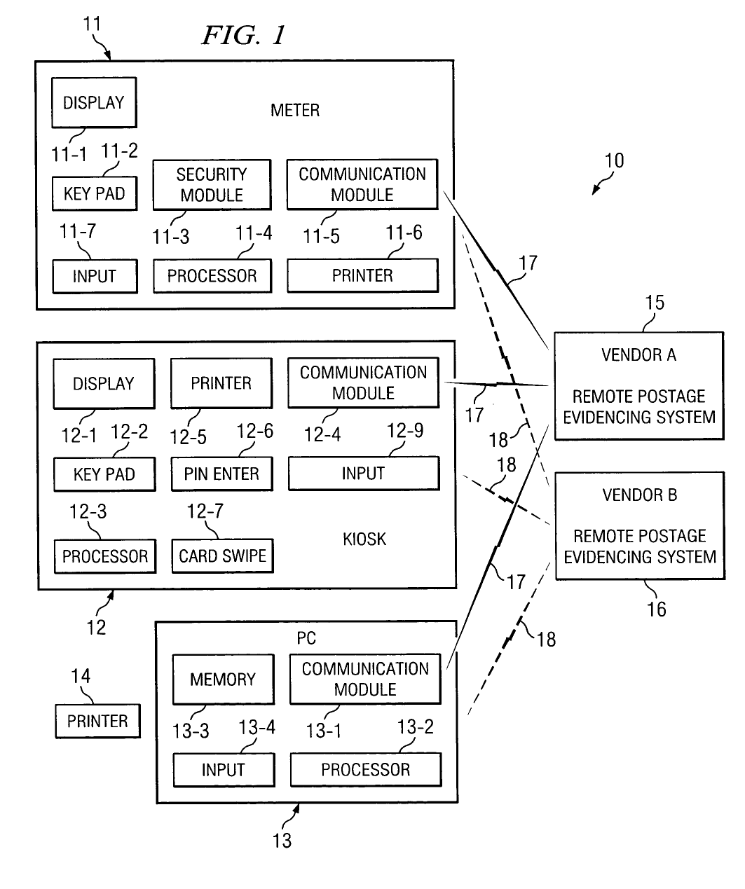

FIG. 1 is a block diagram of system 10 incorporating an embodiment of the present invention. System 10 includes postage meter 11, postage dispensing kiosk 12, and computer 13. In the illustrated embodiment, each component 11, 12, 13 connects to remote server systems 15 and 16, which may be postage evidencing systems, via communication links 17 and 18, respectively. Communication links 17 and 18 may be any wireline or wireless connection or a combination of both, such as a direct cable connection, local area network (LAN), wide area network (WAN), intranet, the Internet, or the like using any protocol now known or later developed that provides for the transmission of data between two or more devices.

When a user accesses postage meter 11, kiosk 12 or computer 13 to print he/she has the option of using via a local postage account balance or a remote postage account balance on evidencing systems 15 or 16. This allows the user to utilize a preexisting account balance instead of making additional postage purchases.

This would be useful, for example, in the situation where a company employee is doing business outside the office and needs to mail something on behalf of the company. The employee under the prior art system would likely have to purchase postage from the self-service kiosk, for example, and then later seek reimbursement from his/her employer, even though the company's postage account balance on an Internet postage service or a USPS account had ample postage available for use. The present invention reduces or even eliminates the need for multiple accounts and the need for postage reimbursements because the company's postage meter accounts are accessible by the employee when he/she needs postage from a self-service postage kiosk. While at postage kiosk 12, the employee may connect to remote postage evidencing system 15 or 16 to call up his/her company's postage account. The user is authenticated by the remote system and is then authorized to print the requested postage amount, if a sufficient balance is present in the postage account on the remote system. After printing the postage, the registers on the remote postage evidencing system are updated to reflect postage that has been evidenced.

Meter 11 is, for example, a meter that would be used in a company mailroom. Meter 11 includes display 11-1, keypad 11-2, security module 11-3, processor 11-4, communication module 11-5, printer 11-6, and input 11-7. Display 11-1 provides a means for viewing values, such as postage balances, the contents of the descending register, the contents of the ascending register, as well as control or postage sum, piece count, batch value, and batch count. Display 11-1 may be a conventional multiplexed LED or LCD display. Display 11-1 also displays information associated with the remote postage evidencing system in a preferred embodiment. In conjunction with display 11-1, key pad 11-2 allows a user to enter his/her selections regarding the desired postage, account balances, remote account information and the like.

Security module 11-3 protects the local postage values and ensures that no unauthorized party gains access to the postage value stored locally on meter 11. Processor 11-4 serves to coordinate and control operations within meter 11. Processor 11-4 may be a microprocessor, Application Specific Integrated Circuit (ASIC) or other like mechanism for completing processing functions.

Communication module 11-5 provides a communication connection between meter 11 and one or more of the remote postage evidencing systems 15, 16. Communication module 11-5 may include a wireless or wireline modem, network interface card, data port, or other appropriate connection for communication links 17, 18.

In a preferred embodiment, meter 11 can be used in the traditional manner to evidence postage from a local account. In this embodiment, meter 11 also can access a remote account on a remote server system. The user approaches meter 11 and identifies himself/herself through an entry on keypad 11-2 or using input 11-7, which may accept a smart card, a printed ticket with an identification code, or other identification method. Meter 11 then determines from one of these identification methods what remote postage evidencing system this user should utilize. The system may default to a particular remote account or may offer the user the choice of multiple remote accounts 15, 16.

If multiple vendors having their own respective remote postage evidencing systems are available, the preferred identification method will identify the appropriate vendor and meter 11 will make a connection via the communication module to the correct remote server system 15,16. The remote server system will authenticate the user and determine how much postage should be transferred from the remote account to local postage meter 11. The postage may be transferred to meter 11 as an electronic transfer of postage value to be added to meter 11 's account balance or may be an authorization to print a particular postage value amount, wherein the postage amount is deducted from a balance on remote server system 15, 16. The remote server system may transfer postage indicia, such as a 2-D bar code, to local postage meter 11. Once the postage amount or postage indicia is received by meter 11, the postage can be printed using printer 11-6.

Postage kiosk 12 provides another method for users to purchase postage. Kiosk 12 includes display 12-1, key pad 12-2, processor 12-3, communication module 12-4, and printer 12-5. These components of kiosk 12 perform similar functions to their counterpart components of meter 11 and, thus, the functionality of these components will not be repeated except to reiterate that communication module 12-4 facilitates communication with remote postage evidencing system 15 or 16. Kiosk 12 also may contain a local security module (not shown) to protect any stored local postage value.

Kiosk 12 allows user to print or dispense postage by paying locally using cash, credit cards, debit cards, or the like. Card swipe 12-7 is used to capture credit or debit card information. PIN entry device 12-6, which may be part of key pad 12-2, allows the user to enter a password or PIN to authorize the use of a credit or debit card. Alternatively, the user may enter cash in a bill reader (not shown) or enter coins in a coin slot (not shown) to purchase postage locally.

Kiosk 12 also provides access to remote postage evidencing systems, such as remote server systems 15, 16, so that the user can pay for postage using remote postage account balances. Preferably, postage indicia in the requested amount or the proper postage value is transmitted to kiosk 12 via communication link 17 or 19, which may be part of the same communication system that is used to access remote credit card and debit card systems.

Alternative input device 12-9 that may accept other forms of identification to authorize postage printing, such as, for example, a paper with a bar code that can be scanned, a smart card, a magnetic stripe card that identifies the user, a biometric thumbprint, hand geometry, retinal scan, a DNA check, or the like. Preferably, the input device extracts or identifies a desired vendor 15, 16. A connection is then made to the appropriate remote system via communication link 17 or 18 in order to extract the actual postage value for the user. As described above for meter 11, remote system 15 or 16 authorizes kiosk 12 to print a certain amount of postage and subtracts that amount from the user's postage account balance.

Personal computer 13 is another device that can be used to download and print postage. For example, a user may access an Internet-based postage service and download a selected postage value for later printing using printer 14. Personal computer 13 contains processor 13-2, which may be any microprocessor or other processor device. Like the processors discussed above in relation to meter 11 and kiosk 12, processor 13-2 is used for coordinating all computing operations in computer 13, including communicating with remote postage evidencing system 15 or 16.

Personal computer 13 includes input 13-4 which can be used to identify desired Internet-based postage accounts. Postage value from these accounts can then be downloaded or transferred to memory 13-3 for later printing. Communication module 13-1 provides the communication interface between computer 13 and remote systems 15, 16. Computer 13 and remote systems 15, 16 may be part of unrelated systems wherein the Internet or other global information exchange system is used to provide communication links 17, 18. Alternatively, computer 13 and remote system 15 and/or 16 may be part of a proprietary network, such as a company's computer network, and communication links 17 and/or 18 are part of a WAN or LAN.

In a traditional system for accessing postage using a personal computer, the user connects to an Internet-based postage service using computer 13. The user then purchases postage using an account established with the Internet postage service provider. The value of the postage is subtracted from the user's account or the user can purchase additional postage, for example, using a credit or debit card at the time of request. The requested amount of postage is transferred to or authorized on computer 13 and can be printed on external printer 14.

FIG. 1 depicts at least three possible mechanisms for accessing one or more remote postage accounts. In one exemplary embodiment, the user has a postage account with the USPS or an Internet-based postage service, such as STAMPS.COM®. The user may typically use personal computer 13 to print postage, however, if the user is at work, he/she may use postage meter 11 at work to print personal postage using the present invention. The user simply enters the appropriate account information and essentially bypasses the local account balance on meter 11. Instead, meter 11 is authorized to print a postage indicia that is transferred from the server hosting the user's remote account.

In another exemplary embodiment, the user access the USPS or Internet postage account via kiosk 12. Accordingly, the user does not need to purchase postage using cash or a credit or debit card. Instead, the kiosk authorizes and prints postage using postage value that is transferred or authorized by the remote account.

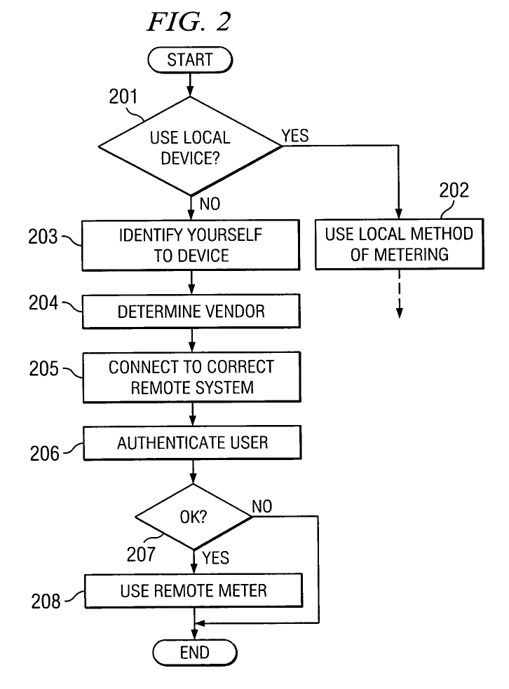

FIG. 2 is a flowchart illustrating a process for using a remote postage account according to embodiments of the present invention. The process begins at 201 where a postage evidencing device receives a selection regarding whether to use a local postage account or a remote postage account. If the local account is selected, then a local metering method is employed at 202. The local method may be using the postage meter, a self-service kiosk, or by purchasing postage through electronic access via a personal computer to a remote postage service.

If a decision is made to not use the local device, then at 203 the user identifies himself/herself to the local device. The identification may be achieved through a key pad input, biometric input, smart card, or other input. Preferably, the desired remote postage service is determined from the user's identification at 204. The user is connected to the remote server or postage evidencing system via a communication link at 205 and the user is authenticated at 206, such as by a user ID, password, or the identification results obtained in the local device authentication at 203.

At 207, the system determines whether the user has been successfully authenticated by the remote system. If proper authentication is not achieved, the user's session will terminate. If the user is properly authenticated, then process 208 permits the user to utilize the remote server system in order to get the proper postage value from his/her preferred postage account. Postage is then printed using the local device.

If there are multiple vendors available for the local device to connect with via a communication link, a preferred vendor ID will then be extracted from the user in order to assure that connection is made to the proper remote postage evidencing system for that vendor at 205. However, if only one vendor is available or the user only has access to one vendor, the user will be connected to the available remote postage evidencing system directly.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system for printing postage on a local postage evidencing device using a remote postage account, comprising:
a local postage evidencing device having a local postage account;
at least one remote server system having one or more remote postage accounts; and
a communication link between the local postage evidencing device and the at least one remote server system, wherein postage value is transferred via the communication link to allow users to print postage on the local postage evidencing device.

2. The system of claim 1 wherein the local postage evidencing device is a postage meter.

3. The system of claim 2 wherein the local postage account is a register that reflects the amount of postage that is currently authorized on the device.

4. The system of claim 1 wherein the local postage evidencing device is a postage dispensing kiosk.

5. The system of claim 4 wherein the local postage account is an amount of postage purchased by a user at the kiosk.

6. The system of claim 1 wherein the local postage evidencing device is a personal computer coupled to a printer.

7. The system of claim 6 wherein the local postage account is a stored value of postage that has been downloaded from an Internet-based postage service.

8. The system of claim 1 wherein the remote server system comprises:
an Internet-based postage service.

9. The system of claim 1 wherein the remote server system comprises a postage account established by the United States Postal Service.

10. The system of claim 1 wherein the remote server system comprises:
a postage meter.

11. The system of claim 1 wherein the communication link is a wireline connection.

12. The system of claim 1 wherein the remote server system comprises:
a personal computer (PC) coupled to a printer.

13. The system of claim 1 wherein the communication link is a wireless connection.

14. A method of accessing a remote postage account from a local postage evidencing device, comprising:
connecting to a remote postage evidencing system via a local postage evidencing device;
identifying a remote postage account on the remote postage evidencing system that is to be used to print postage on the local postage evidencing device;
selecting a desired postage amount to be printed on the local postage evidencing device;
reducing a balance on the remote postage account; and
printing the desired postage amount on the local postage evidencing device.

15. The method of claim 14 further comprising:
printing the desired postage amount on the local postage evidencing device without reducing a balance on the local postage account.

16. The method of claim 14 further comprising:
authenticating a user with the remote postage evidencing system.

17. The method of claim 14 further comprising:
connecting to the remote postage evidencing system using a wireless connection.

18. The method of claim 14 further comprising:
connecting to the remote postage evidencing system using a wireline connection.

19. The method of claim 14 further comprising:
identifying a user to the local postage evidencing device using a biometric input.

20. The method of claim 14 wherein the local postage evidencing device is a postage meter.

21. The method of claim 20 wherein the dedicated local postage account is a register that reflects the amount of postage that is currently authorized on the device.

22. The method of claim 14 wherein the local postage evidencing device is a postage dispensing kiosk.

23. The method of claim 22 wherein the dedicated local postage account is an amount of postage purchased by a user at the kiosk.

24. The method of claim 14 wherein the local postage evidencing device is a personal computer coupled to a printer.

25. The method of claim 24 wherein the local postage account is a stored value of postage that has been downloaded from an Internet-based postage service.

25. The method of claim 14 wherein the remote postage evidencing system is an Internet-based postage service.

26. The method of claim 14 wherein the remote postage evidencing system comprises a postage account established by the United States Postal Service.

27. A computer program product having a computer readable medium having computer program logic recorded thereon for accessing a remote postage account from a local postage evidencing device having a dedicated local postage account, said computer program product comprising:
code for connecting to a remote postage evidencing system via a local postage evidencing device;
code for identifying a remote postage account on the remote postage evidencing system that is to be used to print postage on the local postage evidencing device;
code for selecting a desired postage amount to be printed on the local postage evidencing device; and
code for receiving an authorization from the remote postage evidencing system to print the desired postage amount on the local postage evidencing device.

28. The computer program product of claim 27 comprising:
code for printing the desired postage amount on the local postage evidencing device without reducing a balance on the local postage account.

29. The computer program product of claim 27 comprising:
code for authenticating a user with the remote postage evidencing system.

30. The computer program product of claim 27 comprising:
code for identifying a user to the local postage evidencing device using a biometric input.
